(19) United States
(12) Patent Application Publication
(10) Pub. No.: US 2009/0033632 A1
(43) Pub. Date: Feb. 5, 2009

(54) INTEGRATED TOUCH PAD AND PEN-BASED TABLET INPUT SYSTEM

(76) Inventors: Thomas H. Szolyga, Saratoga, CA (US); Rahul Sood, Calgary (CA); Luca Di Fiore, Taipei (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/830,784

(22) Filed: Jul. 30, 2007

(51) Int. Cl. G06F 3/041

(52) U.S. Cl. 345/173

(57) ABSTRACT

Integrated touch pad and pen-based tablet input devices and systems are described herein. At least some illustrative embodiments include an input device that includes a touch pad that detects when a surface of the touch pad is contacted by a finger of a user (the surface of the touch pad defining a first x-y plane), and a pen-based tablet comprising a sensing array, wherein the sensing array detects when a stylus associated with the sensing array is proximate to the sensing array (the sensing array defining a second x-y plane that is beneath the first x-y plane). The touch pad is mounted above and proximate to the sensing array, such that the sensing array detects when the stylus is proximate to the surface of the touch pad.

### BACKGROUND

A large variety of devices for providing input to computer systems has evolved over the years. A user is no longer limited to just a keyboard and mouse, and is now able to choose between such devices as touch pads, joysticks, game controllers, track balls, touch screens, pointing sticks and pen-based digitizing tablets, just to name a few examples. Each of the devices has its strengths and its weaknesses, and each is used in systems that predominantly perform a particular type of task to which a particular device is well suited. Touch pads, for example, have found wide acceptance in laptops due to their compact size and ease of integration into the laptop form factor. On the other hand, pen-based digitizing tablets are widely used in systems used by graphical artists due to the high resolution of both the positional and pressure sensing capabilities of this type of input device. While some of these devices may be considered by some to be relatively interchangeable for a limited range of applications, other devices are sufficiently specialized as to represent the only practical solution for a given task. The need to support multiple applications thus sometimes necessitates installing separate individual input devices on a single system. Further, while some devices have been easily integrated into portable devices such as laptops, others have proven much more difficult to so integrate.

### BRIEF DESCRIPTION OF THE DRAWINGS

For a detailed description of exemplary embodiments of the invention, reference will now be made to the accompanying drawings in which:

FIG. 1 shows a combination touch pad and pen tablet input device incorporated into a laptop computer, constructed in accordance with at least some illustrative embodiments;

FIGS. 2A and 2B show the layering of the touch pad surface and tablet sensing array of the combination input device of FIG. 1, both assembled and in an exploded view, constructed in accordance with at least some illustrative embodiments;

FIG. 3 shows a block diagram of the laptop computer of FIG. 1, constructed in accordance with at least some illustrative embodiments; and

FIG. 4 shows a configuration of the combination touch pad and pen tablet that permits them to be used together, in accordance with at least some illustrative embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Additionally, the term “system” refers to a collection of two or more hardware and/or software components, and may be used to refer to an electronic device, such as a computer, a portion of a computer, a combination of computers, etc. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

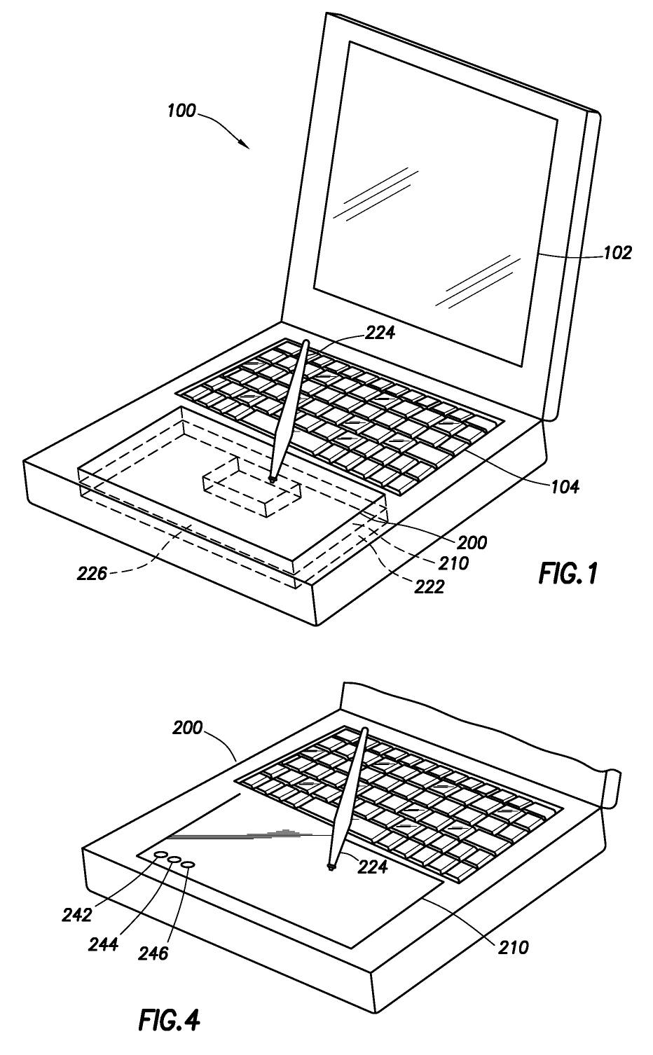

FIG. 1 shows a laptop computer 100 that includes an integrated input device 200 that includes a touch pad 210 and pen-based tablet sensor array 222, constructed in accordance with at least some illustrative embodiments. The surface of the touch pad 210 is the top-most layer of integrated input device 200 and is mounted over sensor array 222. Touch pad 210 of the illustrative embodiment operates using a capacitive sensing technology that operates by detecting changes in the capacitance of the surface of touch pad 210 caused by contact with a finger of a user. By contrast, pen-based tablet sensor array 222 detects that stylus 224 is in close proximity by detecting a radio frequency (RF) signal that is either originated by a transmitter within the stylus (sometimes referred to as an “active” stylus), or that is received by, used to power and is retransmitted by a transceiver within stylus 224 (sometimes referred to as a “passive” stylus). The signal received by the transceiver of stylus 224 is transmitted by optional transmitter 226 of input device 200. Because the detection mechanisms of touch pad 210 and sensor array 222 are different, use of a finger on touch pad 210 is not detected by sensor array 222, and use of stylus 224 in conjunction with sensor array 222 is not detected by touch pad 210.

The illustrative embodiment of FIG. 1 shows a laptop suitable for use as a graphic arts drawing system. It includes a large, high resolution display 102 (e.g., 17 inches with a resolution of 1440×900 pixels), with a correspondingly large lower half of the laptop housing where keyboard 104 and integrated input device 200 are located. As can be seen in FIG. 1, the large lower housing half of laptop 100 allows for a large integrated input device 200. This helps to accommodate a sensor array 222 that is of sufficient size and positional (x-y) resolution as to allow a graphic artist to produce drawings with a drawing resolution that is comparable to the resolution of the displayed image shown on display 102. The ability of the lower housing half to accommodate a full sensor array of such resolution helps to ensure that stylus positions on sensor array 222 map to positions on the screen (sometimes referred to as “isomorphic” mapping), as opposed to touch pad 210 which use relative movement and is not mapped isomorphically to the screen. Thus sensor array 222 must be large enough to be of a resolution comparable to the resolution of the screen.

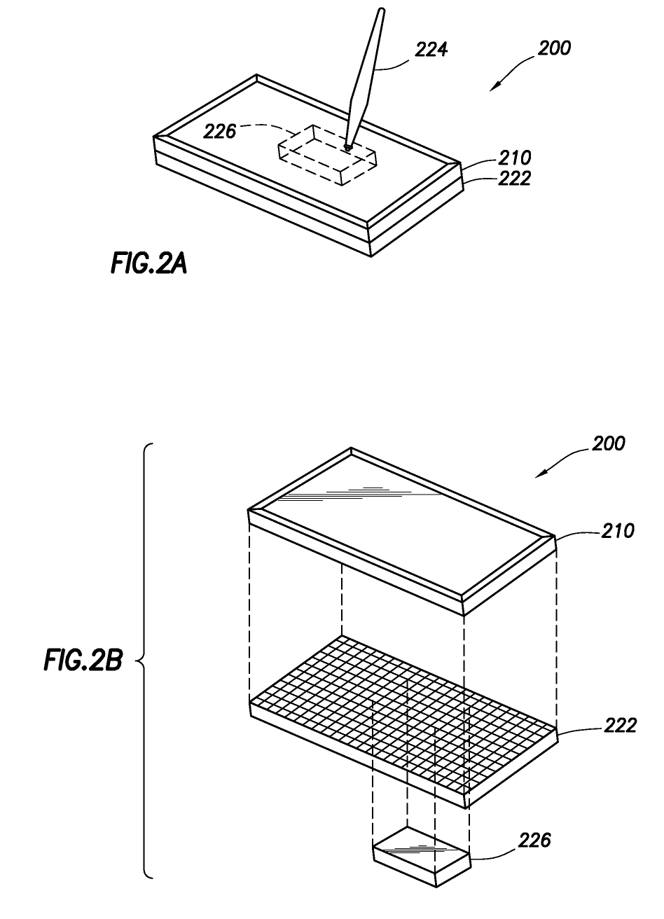

FIGS. 2A and 2B show the integrated input device 200, both assembled and in a simplified exploded view, constructed in accordance with at least some illustrative embodiments. Sensor array 222 mounts directly behind and in close proximity to touch pad 210. By mounting sensor array 222 to the back of touch pad 210 in this manner, stylus 224 will be close enough to sensor array 222 to be detected if it is near or in contact with the surface of touch pad 210. As already noted, contact by stylus 224 with touch pad 210 will not be detected by touch pad 210. This is due to the fact that the materials used to manufacture stylus 224 do not produce the capacitance shift that is necessary to operate touch pad 210. Further, because sensor array 222 is mounted behind touch pad 210, sensor array 222 does not interfere with normal contact and operation by a user of touch pad 210. Touch pad 210 may be attached to sensor array 222 using any of a variety of mounting techniques and hardware, such as screws, nuts and bolts, brackets, and clamps, just to name a few examples. Such mounting techniques and hardware serve to secure the touch pad 210 and sensor array 222 such that they do not move either with respect to each other or with respect to the laptop housing in which they are mounted.

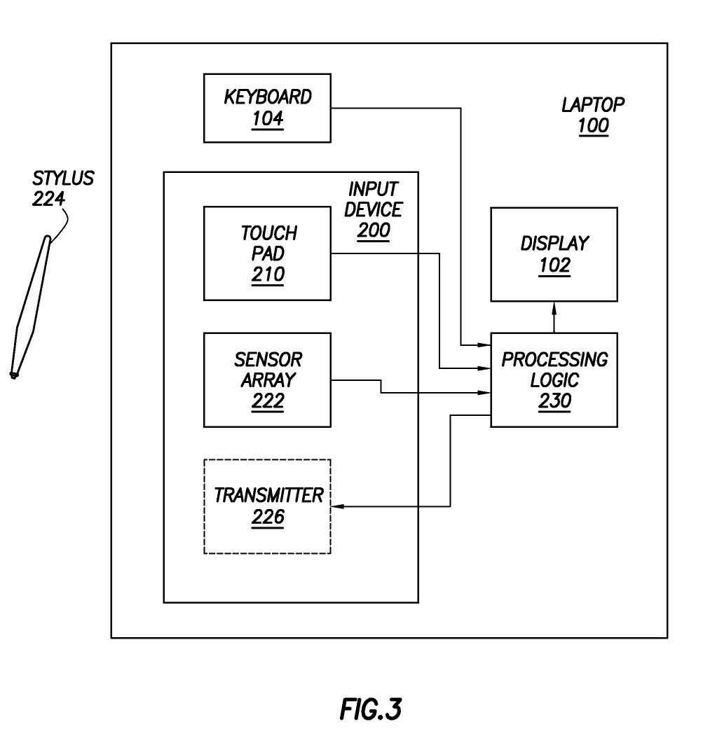

FIG. 3 shows a block diagram of the illustrative laptop of FIG. 1. Display 102, keyboard 104, touch pad 210, sensor array 222, and optional transmitter 226 all couple to processing logic 230. Processing logic 230 may be implemented in hardware (e.g., a microprocessor), software (e.g., embedded firmware), or a combination of hardware and software (e.g., a motherboard). Both touch pad 210 and sensor array 222 provide data to processing logic 230. Touch pad 210 provides x-y positional information of the contact point of a user's finger on the touch pad relative to the x-y plane defined by the surface of the touch pad, as well as z information that reflects the pressure with which a user presses their finger against the surface of touch pad 210. Similarly, sensor array 222 provides x-y positional information of stylus 224 relative to the x-y plane defined by sensor array 222, which is parallel to the x-y plane of touch pad 210, as well as information indicative of the pressure exerted by the user's finger on a sensor point on stylus 224.

The data sent by touch pad 210 and sensor array 222 may be received and processed by processing logic 230 separately and independently, or the data may be combined and processed together, allowing the devices to operate cooperatively. Thus, in at least one illustrative embodiment touch pad 210 may be used to control a cursor that accesses menu options and commands within a drawing program, while the pen-based tablet, which includes sensor array 222 and stylus 224, is used to create and edit the actual drawings after toggling from a command mode to a drawing mode. In at least one other embodiment, the data from both the touch pad and the pen-based tablet are processed concurrently. As shown in FIG. 4, an area of touch pad 210 may be defined as “mouse buttons,” wherein if the user presses touch pad 210 within one or more of these regions (242, 244 and 246 of FIG. 4), processing logic 230 will interpret the presses as mouse button clicks. The touch pad 210 of the illustrative embodiment of FIG. 4 is further capable of detecting and discriminating between multiple, concurrent touch pad contacts, thus allowing combinations of contacts to be interpreted (e.g., pressing and holding a “mouse button” with one finger while moving the cursor using another finger, also in contact with the touch pad). At the same time, stylus 224 may be used to control the cursor and to execute drawing operations, without having to take action to toggle between the two input devices.

The above discussion is meant to be illustrative of the principles and various embodiments of the present invention. Numerous variations and modifications will become apparent to those skilled in the art once the above disclosure is fully appreciated. For example although the illustrative embodiments of the present disclosure are shown and described within the context of a laptop computer, other types of computer systems are also equally well suited for use with integrated input device 200. It is intended that the following claims be interpreted to embrace all such variations and modifications.

What is claimed is:

1. An input device, comprising:
a touch pad that detects when a surface of the touch pad is contacted by a finger of a user, the surface of the touch pad defining a first x-y plane; and
a pen-based tablet comprising a sensing array, wherein the sensing array detects when a stylus associated with the sensing array is proximate to the sensing array, the sensing array defining a second x-y plane that is beneath the first x-y plane;
wherein the touch pad is mounted above and proximate to the sensing array, such that the sensing array detects when the stylus is proximate to the surface of the touch pad.

2. The input device of claim 1, wherein the touch pad and the pen-based tablet each operate independently of each other.

3. The input device of claim 1, wherein the stylus comprises an active radio frequency transmitter that emits a signal used by the sensing array to detect when the stylus is proximate to the input device, and to determine the x-y position of the stylus relative to the second x-y plane.

4. The input device of claim 1,
wherein the pen-based tablet further comprises a radio frequency (RF) transmitter and the stylus comprises an RF transceiver that is powered and activated by a first signal transmitted by the RF transmitter; and
wherein the sensing array receives a second signal, transmitted by the stylus in response to the first signal, the second signal used by the sensing array to detect when the stylus is proximate to the input device, and to determine the x-y position of the stylus relative to the second x-y plane.

5. The input device of claim 1, wherein the stylus detects a pressure exerted by the finger of the user on a sensing point on the stylus.

6. The input device of claim 1, wherein the touch pad detects the x-y position of the point of contact of the finger of the user relative to the first x-y plane.

7. The input device of claim 1, wherein the touch pad detects when one or more fingers contact the touch pad and discriminates between each contact.

8. The input device of claim 1, wherein the touch pad detects the pressure exerted by the finger of the user on the surface of the touch pad.

9. A system, comprising:
an input device comprising a touch pad that detects when a surface of the touch pad is contacted by a finger of a user, and a pen-based tablet comprising a sensing array and a stylus, wherein the sensing array detects when a stylus associated with the sensing array is proximate to the sensing array; and
processing logic coupled to the input device that receives data from the touch pad when a finger of a user contacts a surface of the touch pad, and further receives data from the pen-based tablet when the stylus is proximate to the sensing array;
wherein the surface of the touch pad defines a first x-y plane and the sensing array defines a second x-y plane underneath the first x-y plane; and
wherein the touch pad is mounted above and proximate to the sensing array, such that the sensing array detects when the stylus is proximate to the surface of the touch pad.

10. The system of claim 9, wherein the data received by the processing logic from the touch pad comprises information that reflects the x-y positions of the finger of the user relative to the first x-y plane, and information reflecting the pressure exerted by the finger of the user on the surface of the touch pad.

11. The system of claim 9, wherein the data received by the processing logic from the sensing array comprises information that reflects the x-y position of the stylus relative to the second x-y plane, and information reflecting the pressure exerted by the finger of the user on a sensing point on the stylus.

12. The system of claim 9, wherein the processing logic processes the data from the touch pad and the data from the sensing array independently.

13. The system of claim 9, wherein the processing logic combines and processes the data from the touch pad and the data from the sensing array.

14. The system of claim 9, wherein the processor maps multiple finger contacts on the surface of at least a portion of the touch pad to buttons on a mouse.

15. The system of claim 9, wherein the system is a laptop computer.

16. The system of claim 9, wherein the stylus is a passive stylus and the pen-based tablet comprises a radio frequency transmitter that transmits a signal that is received by and powers the passive stylus.

17. The system of claim 9, wherein the stylus is an active stylus that transmits a radio frequency signal detected by the sensing array.

18. A system, comprising:
first means for detecting user input from a user's finger;
second means for detecting user input from a stylus; and
means for processing data coupled to the first and second means for detecting, the means for processing receives and processes data from the first and second means for detecting;
wherein the first means for detecting is mounted on top of the second means; and
wherein the second means for detecting identifies the position of the stylus relative to the second means for detecting when the stylus is proximate to the first means for detecting.

19. The system of claim 18,
wherein the data received by the means for processing from the first means for detecting comprises information that reflects the x-y positions of the user's finger relative to a surface of the first means for detecting, and information reflecting the pressure exerted by the finger of the user on the surface of the touch pad; and
wherein the data received by the means for processing from the second means for detecting comprises information that reflects the x-y position of the stylus relative to an x-y plane defined by the second means for detecting, and information reflecting the pressure exerted by the finger of the user on a sensing point on the stylus.

20. The system of claim 18, wherein the means for processing processes the data received from the first means for detecting independent of the data received from the second means for detecting.
